(19) United States
(12) Patent Application Publication
(10) Pub. No.: US 2019/0126926 A1
(43) Pub. Date: May 2, 2019

(54) STEERING SPEED CONTROL

(71) Applicant: Ford Global Technologies, LLC, Dearborn, MI (US)

(72) Inventors: Jason Maynard, Canton, MI (US); Kenneth Michael Mayer, Ypsilanti, MI (US); John Shutko, Ann Arbor, MI (US); Benjamin Osafo-yeboah, South Lyon, MI (US); Shane Elwart, Ypsilanti, MI (US)

(73) Assignee: Ford Global Technologies, LLC, Dearborn, MI (US)

(21) Appl. No.: 15/794,823

(22) Filed: Oct. 26, 2017

(51) Int. Cl. B60W 30/18; G05D 1/00

(52) U.S. Cl. CPC B60W 30/18145; G05D 1/0061; G05D 1/0066; B60W 2510/202; B60W 2540/10; B60W 2530/10; B60W 2550/146; B60W 2520/18; B60W 2550/148; B60W 2720/10; B60W 2520/10

(57) ABSTRACT

A system includes a processor and a memory. The memory stores instructions executable by the processor to determine a maximum vehicle speed based on a road curvature. The memory stores instructions to limit a vehicle speed at the determined maximum vehicle speed, upon receiving a user acceleration request while a user torque request at a vehicle steering wheel is undetected.

### BACKGROUND

One or more computers can be programmed to control vehicle operations, e.g., as a vehicle travels on a road. For example, a computer may control vehicle operation in an autonomous mode, e.g., by controlling the vehicle acceleration, braking, and steering. However, upon receiving user input to accelerate the vehicle, e.g., a user pushes on a vehicle gas pedal, problems arise in a vehicle steering system and/or in determining whether to apply the user input at all.

### BRIEF DESCRIPTION OF THE DRAWINGS

FIG. 1 is a diagram of an example vehicle including an example steering system.

FIG. 2 is a block diagram of the steering system of FIG. 1.

FIG. 3 is a block diagram showing the vehicle moving on a curved road.

FIG. 4 is a flowchart of an exemplary process for controlling vehicle operation.

### DETAILED DESCRIPTION

### Introduction

Disclosed is a system that includes a processor and a memory. The memory stores instructions executable by the processor to determine a maximum vehicle speed based on a road curvature, and to limit a vehicle speed at the determined maximum vehicle speed, upon receiving a user acceleration request while a user torque request at a vehicle steering wheel is undetected.

The instructions may further include instructions to determine the maximum vehicle speed based on a radius of the road curvature.

The instructions may further include instructions to determine the maximum vehicle speed based on at least one of a vehicle mass, a vehicle body characteristic, and a road surface characteristic.

The vehicle body characteristic may be a location of a vehicle center of gravity.

The road surface characteristic may be a friction coefficient of a road surface.

The instructions may further include instructions to actuating a vehicle component to increase vehicle speed based on the received user acceleration request only upon determining that at least one of a user torque is applied to the steering wheel and the vehicle speed is less than the determined maximum vehicle speed.

The instructions may further include instructions to deactivate a vehicle autonomous mode of operation, upon receiving a user acceleration request while a user torque request at a vehicle steering wheel is undetected.

The instructions may further include instructions to determine the user acceleration request based on data received from a vehicle accelerator pedal sensor.

Further disclosed herein is a method that includes determining a maximum vehicle speed based on a road curvature, and limiting a vehicle speed at the determined maximum vehicle speed upon receiving a user acceleration request while a user torque request at a vehicle steering wheel is undetected.

The method may further include determining the maximum vehicle speed based on a radius of the road curvature.

The method may further include determining the maximum vehicle speed based on at least one of a vehicle mass, a vehicle body characteristic, and a road surface characteristic.

The vehicle body characteristic may be a location of a vehicle center of gravity.

The road surface characteristic may be a friction coefficient of a road surface.

The method may further include further include actuating the vehicle component to increase vehicle speed based on the received user acceleration request only upon determining that at least one of a user torque is applied to the steering wheel and the vehicle speed is less than the determined maximum vehicle speed.

The method may further include deactivating a vehicle autonomous mode of operation, upon receiving a user acceleration request while a user torque request at a vehicle steering wheel is undetected.

The method may further include determining the user acceleration request based on data received from a vehicle accelerator pedal sensor.

Further disclosed is a computing device programmed to execute the any of the above method steps. Yet further disclosed is a vehicle comprising the computing device.

Yet further disclosed is a computer program product, comprising a computer readable medium storing instructions executable by a computer processor, to execute any of the above method steps.

### Exemplary System Elements

A computer of a vehicle such as an autonomous vehicle may control a vehicle steering operation. A user may accelerate the vehicle, e.g., by pushing a vehicle gas pedal, while the computer controls the vehicle steering operation. In this scenario, an increased vehicle speed may interfere with the vehicle steering operation. Thus, the computer can advantageously determine to actuate a vehicle steering acceleration and/or steering actuator based on the user input (i.e., applied acceleration input). Thus, advantageously, vehicle operation may be improved with regard to maintaining a driving lane of the vehicle, e.g., by preventing acceleration of the vehicle when the computer determines that acceleration of the vehicle may cause a lane departure.

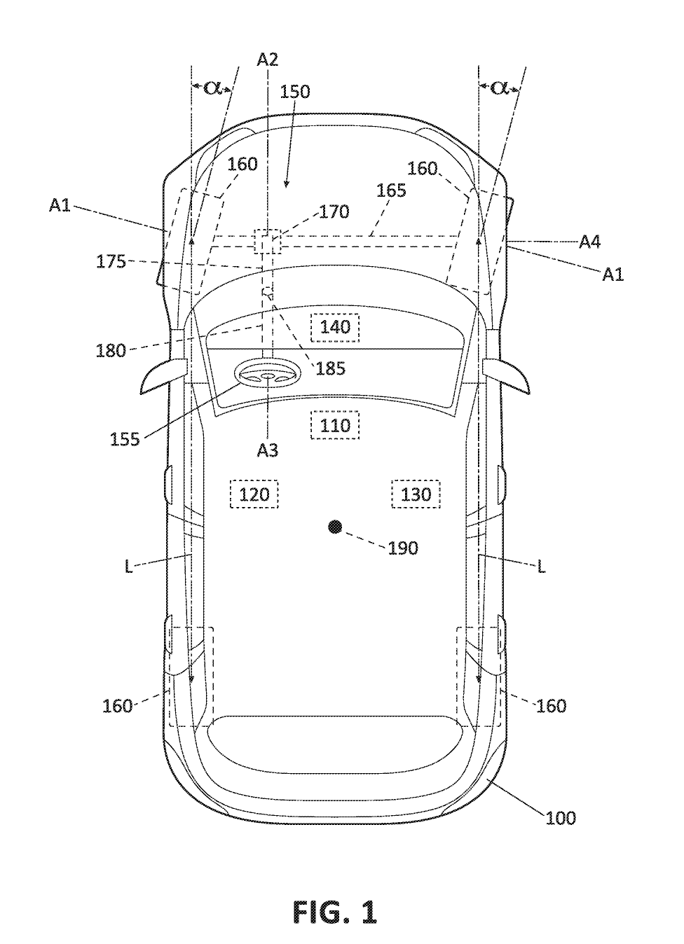

FIG. 1 illustrates an example vehicle 100. The vehicle 100 may be powered in a variety of known ways, e.g., with an electric motor and/or internal combustion engine. The vehicle 100 is a land vehicle such as a car, truck, etc. A vehicle 100 may include a computer 110, actuator(s) 120, sensor(s) 130, a human machine interface (HMI) 140, a steering system 150, and a center of gravity 190.

The computer 110 includes a processor and a memory such as are known. The memory includes one or more forms of computer-readable media, and stores instructions executable by the computer 110 for performing various operations, including as discussed herein.

The computer 110 may operate the respective vehicle 100 in an autonomous or a semi-autonomous mode. For purposes of this disclosure, an autonomous mode is defined as one in which each of vehicle 100 propulsion, braking, and steering are controlled by the computer 110; in a semi-autonomous mode, the computer 110 controls one or two of vehicle 100 propulsion, braking, and steering.

The computer 110 may include programming to operate one or more of vehicle 100 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 100 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 100 network, the computer 110 may transmit messages to various devices in the vehicle 100 and/or receive messages from the various devices, e.g., an actuator 120, a sensor 130, an HMI 140, etc. Alternatively or additionally, in cases where the computer 110 actually comprises multiple devices, the vehicle 100 communication network may be used for communications between devices represented as the computer 110 in this disclosure. Further, as mentioned below, various controllers and/or sensors may provide data to the computer 110 via the vehicle communication network.

The HMI(s) 140 may be configured to receive information from a user, such as a human operator, during operation of the vehicle 100. Moreover, an HMI 140 may be configured to present information to the user. As one example, an HMI 140 may include a touchscreen, buttons, knobs, keypads, microphone, and so on for receiving information from a user. Moreover, an HMI 140 may include various interfaces such as may be provided by a vehicle 100 manufacturer (e.g., the Ford SYNC® system), a smart phone, etc., for receiving information from a user and/or output information to the user.

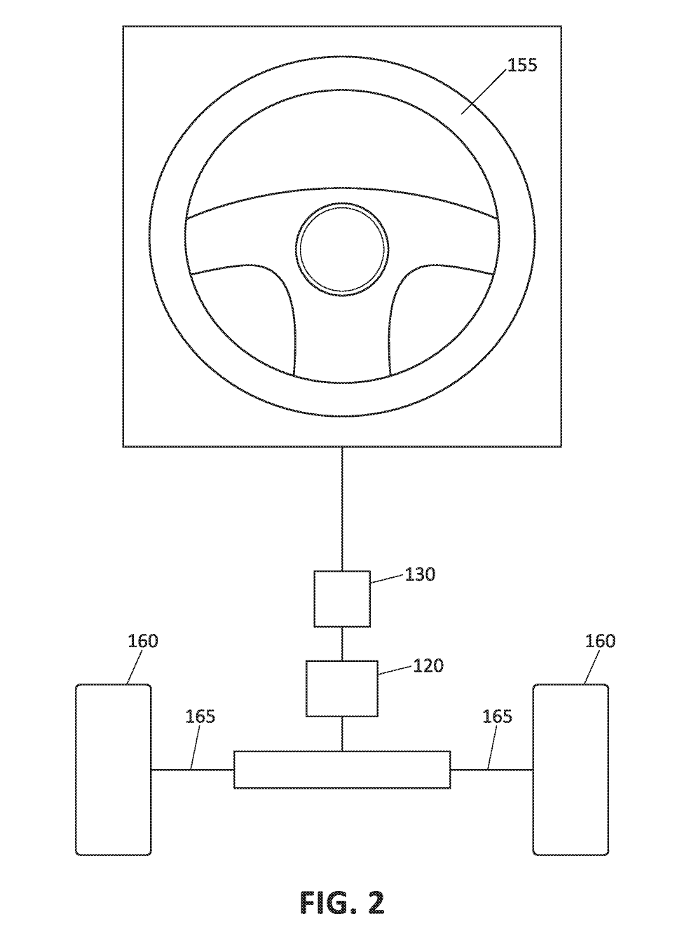

The sensors 130 may include a variety of devices to provide data to the computer 110. For example, the sensors 130 may include Light Detection And Ranging (LIDAR) sensor(s) 130, camera sensors 130, radar sensors 130, etc. disposed in and/or on the vehicle 100 that provide relative locations, sizes, and shapes of other objects such as other vehicles. As another example illustrated in FIG. 2, the vehicle 100 may include torque sensors 130 that provide torque data from sensors 130 connected to various components of the steering system 150.

The steering system 150 may include various conventional steering components, such as a steering wheel 155, wheel(s) 160, a rack 165, a pinion 170, a torsion bar 175, a steering column 180, and a mechanical joint 185 mechanically coupling the torsion bar 175 and the steering column 180. Further, the vehicle 100 pinion 170 may be mechanically coupled to a vehicle 100 steering rack 165 and, via the torsion bar 175 and the steering column 180, to the vehicle 100 steering wheel 155.

Additionally or alternatively, a vehicle 100 user may steer the vehicle 100 by applying torque to the vehicle 100 steering wheel 155. For example, the vehicle 100 user may rotate the steering wheel 155 about an axis A3 of the steering column 180 in a clockwise direction to steer the vehicle 100 to a rightward direction. The steering column 180 and the torsion bar 175 may be mechanically connected via the mechanical joint 185. Thus, a rotation of the steering column 180 may apply torque to the torsion bar 175 and cause the torsion bar 175 to twist about an axis A2. Twisting the torsion bar 175 may in turn apply torque to the pinion 170 to thereby rotate the pinion 170 to rotate about the axis A2.

Further, the rack 165 and the pinion 170 may be mechanically connected. Thus, the torque applied to the pinion 170 may move the rack 165, e.g., to a right and/or left direction along an axis A4 of the rack 165. A movement of the rack 165 in a right or left direction in turn pivots axes A1 of the wheels 160 about an axis (not shown) that is perpendicular to a ground surface and passing through a center of the wheel 160, i.e., to use lay parlance, turns the wheels 160. This pivoting of the wheel 160 axes A1 may change a vehicle 100 steering direction. Additionally or alternatively, a steering actuator 120 may apply torque to the pinion 170 to steer the vehicle 100. In one example, illustrated in FIG. 2, the computer 110 may be programmed to actuate a vehicle 100 actuator 120 to steer the vehicle 100 while the vehicle 100 is operated in an autonomous or semi-autonomous mode. For example, in the semi-autonomous mode, the computer 110 may actuate the vehicle 100 steering actuator 120 based on the vehicle 100 sensor 130 data, whereas a vehicle 100 user may accelerate and/or decelerate the vehicle 100 by pushing the gas and/or brake pedal(s).

The computer 110 may be programmed to receive torque data (e.g., an amount of torque currently being applied) from a torque sensor 130 coupled to the steering column 180. In another example, the torque sensor 130 may be coupled to the pinion 170. The torque data received from the sensor(s) 130 is data that specifies vehicle 100 steering torque, i.e., torque being applied to the steering column 180. The torque sensor 130 may be a transducer that converts a torsional mechanical input into an electrical signal output. The computer 110 may be programmed to determine a steering torque based on the received sensor 130 data such as received torque data from the torque sensor 130. In one example, the computer 110 may be programmed to determine a user torque request based on an actuation command sent to the steering actuator 120 and the received torque data from the torque sensor 130. For example, the computer 110 may determine a user torque request by determining a difference between the applied torque by the actuator 120 (which can be determined based on the actuation command sent by the computer 110 to the steering actuator 120) and the received torque data from the torque sensor 130.

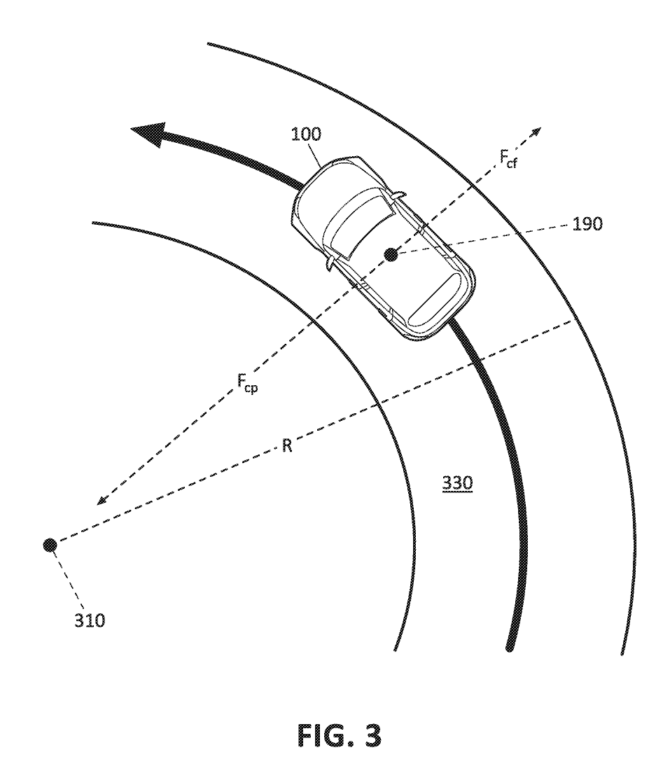

The computer 110 may operate the vehicle 100 steering operation in an autonomous mode by actuating the vehicle 100 steering actuators 120 based at least in part on data received from the vehicle 100 sensor 130. While the computer 110 actuates the steering actuator 120 to operate the vehicle 100 steering, the computer 110 may receive user acceleration request, e.g., from the vehicle 100 accelerator pedal sensor 130. The computer 110 can be programmed to determine a maximum vehicle 100 speed based on a road curvature. The computer 110 can be further programmed to actuate a vehicle 100 component to limit a vehicle 100 speed to the determined maximum vehicle 100 speed, upon receiving a user acceleration request while not detecting a user torque request at a vehicle 100 steering wheel 155. Thus, the computer 110 may operate the vehicle 100 steering autonomously or semi-autonomously only if the vehicle 100 speed is less than the maximum vehicle 100 speed. Determination of maximum vehicle 100 speed is discussed in more detail below with reference to FIG. 3.

That a user torque request in not detected (or undetected) means that the vehicle 100 user is not detected to be applying any torque to the steering wheel 155; therefore, the torque applied to pinion 170 can be determined to be caused by the actuation of the steering actuator 120 rather than a user torque request. The computer 110 may be programmed to determine that a user torque request is undetected upon determining that a current measured or detected user torque request is less than a torque threshold, e.g., 0.2 Newton Meter (NM). Additionally or alternatively, the computer 110 may be programmed based on other known techniques to determine whether the vehicle 100 user holds, i.e., has one or both hands on, the steering wheel 155, and then to determine a lack of a user torque request, i.e., that the user torque request is undetected, upon determining that the user does not hold the steering wheel 155.

The computer 110 may be programmed to determine a user acceleration request based on data received from a vehicle 100 accelerator pedal sensor 130. The accelerator pedal sensor 130 may be a pressure and/or resistive transducer, etc. The computer 110 may be programmed to actuate the vehicle 100 to accelerate and/or decelerate based on the received acceleration request from the acceleration pedal sensor 130.

The computer 110 may be programmed to actuate a vehicle 100 component to limit a vehicle 100 speed at the determined maximum vehicle speed by preventing an acceleration of the vehicle 100 upon determining that the vehicle 100 speed has reached the maximum vehicle 100 speed. Additionally or alternatively, the computer 110 may be programmed to deactivate an autonomous operation of the vehicle 100 steering operation upon determining that the vehicle 100 speed has reached the maximum vehicle 100 speed. Yet additionally or alternatively, the computer 110 may be programmed to output a message to the vehicle 100 HMI 140 indicating that an increase of speed may deactivate the autonomous vehicle 100 steering operation. The computer 110 may be programed to deactivate the autonomous vehicle 100 steering operation if the vehicle 100 user maintains an acceleration request for at least a predetermined time duration, e.g., 5 seconds. In other words, the computer 110 may deactivate the autonomous operation of the vehicle 100 steering upon determining that the user acceleration request is received for at least 5 seconds after the vehicle 100 speed reached the maximum vehicle 100 speed and/or the message was outputted to the vehicle 100 HMI 140 indicating that an increase of the vehicle 100 speed may deactivate the autonomous operation of the vehicle 100 steering.

The computer 110 may be programmed to actuate a vehicle 100 actuator 120, e.g., a powertrain actuator 120, to increase the vehicle 100 speed based on the received user acceleration request upon determining that at least one of (i) a user torque is applied to the steering wheel 155 and (ii) the vehicle 100 speed is less than the determined maximum vehicle 100 speed.

As shown in FIG. 3, the vehicle 100 with a center of gravity 190 may drive on a curvature with a radius R having a center point 310, i.e., a road with a curvature radius R. Moving the vehicle 100 around the center point 310 applies a centrifugal force F_{cf} and a centripetal force F_{cp} to the vehicle 100. The centripetal force F_{cp} is a force exerted to the vehicle 100 in a direction toward the center point 310. The centrifugal force F_{cf} is an inertial resistance force of the vehicle 100 resisting the centripetal force F_{cp}. When the centrifugal force F_{cf} exceeds the centripetal force F_{cf}, the vehicle 100 may exit a current lane 330 on the road, roll over, etc. The centrifugal force F_{cf} is based at least on the vehicle 100 mass, speed, the radius R, etc.

In one example, the computer 110 may be programmed to determine the maximum vehicle 100 speed based on the radius R of the road curvature. In one example, a vehicle 100 steering angle α can be defined as a function of a vehicle 100 wheelbase L and the radius R, as:

$$tan ( α ) = \frac{L}{R}$$

The wheelbase L is a distance between a center of a front wheel 160 and a center of the rear wheel 160 on a same side of the vehicle 100. The function tan is the trigonometric tangent. In one example, the computer 110 may be programmed to determine the maximum speed v based on the formula:

$$v = \frac{τ}{α}$$

Thus, the maximum torque to maintain the lane 330 is directly related to the vehicle 100 speed v and inversely related to the radius R of the lane 330. The computer 110 may be programmed to determine a torque τ applied to the vehicle 100 pinion 170 steering column that is necessary to maintain the current lane 330, e.g., based on vehicle 100 mass, yaw rate, etc. In other words, the torque τ is an amount of torque preventing that the centrifugal force F_{cf} exceeds the centripetal force F_{cf}, as discussed above. The computer 110 may be programmed to determine the radius R based on map data and location coordinates received from the vehicle 100 GPS (global positioning system) sensor 130. Additionally or alternatively, the computer 110 may be programmed to calculate the radius R based on the vehicle 100 yaw rate received from a vehicle 100 yaw rate sensor 130.

Additionally or alternatively, the computer 110 may be programmed to determine the maximum vehicle 100 speed based on at least one of a vehicle 100 mass, a vehicle 100 body characteristic, and a road surface characteristic. The centrifugal force F_{cf} depends on the vehicle 100 mass. Thus, the computer 110 may be programmed to determine the maximum vehicle 100 speed based on the vehicle 100 mass. The computer 110 may be programmed to determine the vehicle 100 mass based on information stored in the computer 110 memory.

The road surface characteristic may include a friction coefficient of a road surface. The centripetal force F_{cf} may be applied to the vehicle 100 as a friction force applied to vehicle 100 wheels 160 tires in a lateral direction toward the center point 310. The friction force depends at least in part on the friction coefficient of the road surface and/or a friction coefficient of the tires. The computer 110 may be programmed to receive road data including the road surface characteristic, the radius R of the road, weather data, etc., from the vehicle 100 sensors 130 and/or a remote computer. In one example, the computer 110 may be programmed to determine a road friction coefficient based on the weather data, e.g., precipitation, temperature, etc.

The vehicle 100 body characteristic may include a location of the vehicle 100 center of gravity 190, e.g., a height of the center of gravity 190 from a ground surface. In one example, the vehicle 100 may roll over, when the centrifugal force F_{cf} exceeds the laterally applied friction force to the wheels 160. For example, whether the vehicle 100 rolls over may be further dependent on a location of the vehicle 100 center of gravity 190, e.g., a height of the center of gravity 190 from a ground surface. Thus, the computer 110 may determine the maximum vehicle 100 speed further based on the location of the center of gravity 190, e.g., an increase of the height of center of gravity 190 may decrease the maximum vehicle 100 speed.

### Processing

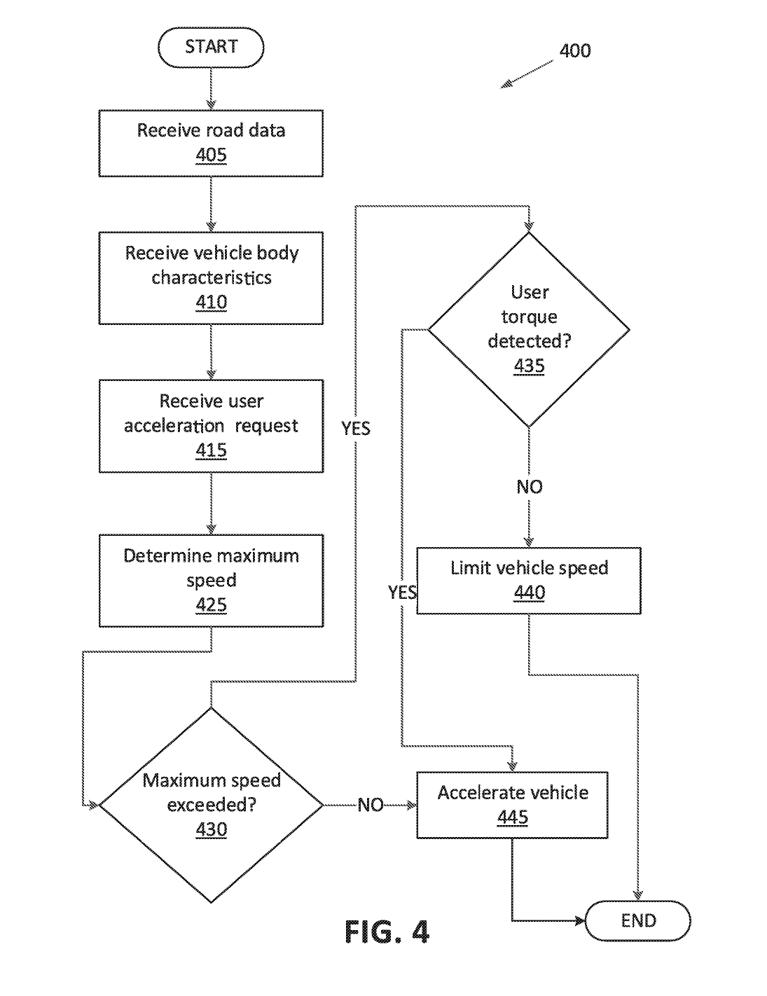

FIG. 4 is a flowchart of an exemplary process 400 for controlling vehicle 100 operation. For example, the vehicle 100 computer 110 may be programmed to execute block of the process 400.

The process 400 begins in a block 405, in which the computer 110 receives road data. The road data may include road surface characteristic, the radius R of the road, the weather data, etc. For example, the computer 110 may be programmed to receive the road data from the vehicle 100 sensors 130 and/or a remote computer.

Next, in a block 410, the computer 110 receives the vehicle 100 body characteristic. For example, the computer 110 may be programmed to receive data including the vehicle 100 mass, location of the vehicle 100 center of gravity 190, etc. In one example, the vehicle 100 body characteristic may be stored in a computer 110 memory.

Next, in a block 415, the computer 110 receives the user acceleration request. For example, the computer 110 may be programmed to receive the user acceleration request from the acceleration pedal sensor 130.

Next, in a block 425, the computer 110 determines the maximum vehicle 100 speed. As explained above, the computer 110 may be programmed to determine the maximum vehicle 100 speed based on the received road data, e.g., the radius R, the friction coefficient, etc., and/or the received vehicle 100 body characteristic, e.g., the height of the center of gravity 190 from the ground surface, etc.

Next, in a decision block 430, the computer 110 determines whether the maximum vehicle 100 speed is exceeded. For example, the computer 110 may be programmed to determine whether the vehicle 100 speed has exceeded the determined maximum vehicle 100 speed based on the vehicle 100 speed received from a vehicle 100 speed sensor 130. If the computer 110 determines that the maximum vehicle 100 speed is exceeded, then the process 400 proceeds to a decision block 435; otherwise the process 400 proceeds to a block 445.

In the decision block 435, the computer 110 determines whether a user torque is detected. For example, the computer 110 may be programmed to determine the user torque request based on the torque received from the torque sensor 130 and the torque amount for which the steering actuator 120 is actuated. A determine user torque request may be 0 (zero) or an amount less than a predetermined torque threshold, e.g., 0.2 NM, when the user torque is undetected, e.g., when the user does not hold the steering wheel 155. If the computer 110 determines that the user torque is detected, then the process 400 proceeds to a block 445; otherwise the process 400 proceeds to a block 440.

In the block 440, the computer 110 limits the vehicle 100 speed to the determined maximum vehicle 100 speed. For example, the computer 110 may be programmed to prevent an acceleration of the vehicle 100 and/or decelerate the vehicle 100 by actuating a vehicle 100 brake actuator 120. Additionally or alternatively, the computer 110 may be programmed to output a message to the HMI 140 indicating that the vehicle 100 speed exceeds the maximum vehicle 100 speed. Yet further additionally or alternatively, the computer 110 may be programmed to deactivate the autonomous operation of the vehicle 100 steering if the user acceleration request is received for more than a predetermined time duration, e.g., 5 seconds (e.g., if the vehicle 100 user keeps pushing the gas pedal although a message has been outputted to the HMI 140 indicating that the autonomous operation of the vehicle 100 steering may deactivate). Following the block 440, the process 400 ends, or alternatively returns to the block 405, although not shown in FIG. 4.

In the block 445, the computer 110 actuate the vehicle 100 actuator(s) 120 to accelerate the vehicle 100. For example, the computer 110 may be programmed to cause an acceleration of the vehicle 100 proportional to the received user acceleration request. Following the block 445, the process 400 ends, or alternatively returns to the block 405, although not shown in FIG. 4.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a processor and a memory, the memory storing instructions executable by the processor to:
determine a maximum vehicle speed based on a road curvature; and
upon receiving a user acceleration request while a user torque request at a vehicle steering wheel is undetected, limit a vehicle speed at the determined maximum vehicle speed.

2. The system of claim 1, wherein the instructions further include instructions to determine the maximum vehicle speed based on a radius of the road curvature.

3. The system of claim 1, wherein the instructions further include instructions to determine the maximum vehicle speed based on at least one of a vehicle mass, a vehicle body characteristic, and a road surface characteristic.

4. The system of claim 3, wherein the vehicle body characteristic is a location of a vehicle center of gravity.

5. The system of claim 3, wherein the road surface characteristic is a friction coefficient of a road surface.

6. The system of claim 1, wherein the instructions further include instructions to actuate a vehicle component to increase vehicle speed based on the received user acceleration request only upon determining that at least one of a user torque is applied to the steering wheel and the vehicle speed is less than the determined maximum vehicle speed.

7. The system of claim 1, wherein the instructions further include instructions to deactivate a vehicle autonomous mode of operation, upon receiving a user acceleration request while a user torque request at a vehicle steering wheel is undetected.

8. The system of claim 1, wherein the instructions further include instructions to determine the user acceleration request based on data received from a vehicle accelerator pedal sensor.

9. A method, comprising:
determining a maximum vehicle speed based on a road curvature; and
upon receiving a user acceleration request while a user torque request at a vehicle steering wheel is undetected, limiting a vehicle speed at the determined maximum vehicle speed.

10. The method of claim 9, further comprising determining the maximum vehicle speed based on a radius of the road curvature.

11. The method of claim 9, further comprising determining the maximum vehicle speed based on at least one of a vehicle mass, a vehicle body characteristic, and a road surface characteristic.

12. The method of claim 11, wherein the vehicle body characteristic is a location of a vehicle center of gravity.

13. The method of claim 11, wherein the road surface characteristic is a friction coefficient of a road surface.

14. The method of claim 9, further comprising actuating a vehicle component to increase vehicle speed based on the received user acceleration request only upon determining that at least one of a user torque is applied to the steering wheel and the vehicle speed is less than the determined maximum vehicle speed.

15. The method of claim 9, further comprising deactivating a vehicle autonomous mode of operation, upon receiving a user acceleration request while a user torque request at a vehicle steering wheel is undetected.

16. The method of claim 9, further comprising determining the user acceleration request based on data received from a vehicle accelerator pedal sensor.
